(19) United States
(12) Patent Application Publication
(10) Pub. No.: US 2017/0366371 A1
(43) Pub. Date: Dec. 21, 2017

(54) COMMUNICATION DEVICE SETTING APPARATUS

(71) Applicant: FUJITSU LIMITED, Kawasaki-shi (JP)

(72) Inventor: Takahiro KIDA, Oota (JP)

(73) Assignee: FUJITSU LIMITED, Kawasaki-shi (JP)

(21) Appl. No.: 15/692,554

(22) Filed: Aug. 31, 2017

Related U.S. Application Data
(63) Continuation of application No. PCT/JP2015/056112, filed on Mar. 2, 2015.

(51) Int. Cl. H04L 12/40; H04L 12/46

(52) U.S. Cl. CPC H04L 12/40039; H04L 12/4641

(57) ABSTRACT

According to an aspect, a communication device setting apparatus, that performs setting in a plurality of switch devices, includes a setting control unit, a power supply control unit, and a setting unit. The setting control unit sequentially selects the setting contents with respect to the switch devices whose wire connection has been completed. The power supply control unit performs control to supply power to the switch devices in which the setting contents selected by the setting control unit are to be set. The setting unit performs setting according to the setting contents, which are selected by the setting control unit, in the switch devices to which power is supplied by the power supply control unit.

### CROSS-REFERENCE TO RELATED APPLICATION

This application is a continuation of International Application No. PCT/JP2015/056112, filed on Mar. 2, 2015, the entire contents of which are incorporated herein by reference.

### FIELD

The embodiment discussed herein is related to a communication device setting apparatus.

### BACKGROUND

In the case of building a system such as a data center in which a plurality of communication devices such as network switches is connected to each other; firstly, individual communication devices are installed at installation locations such as racks, and power is supplied thereto. Then, initial setting is separately performed in each individual communication device. That is followed by a wire connection task in which the communication devices whose initial setting has been completed are wire-connected using network cables. After the wire connection task is completed, function settings related to coordinated operations are performed to the communication devices.

When the system grows large in scale, the number of communication devices also increases, thereby leading to an increase in the number of cables used in wire-connecting the communication devices. For that reason, in a large-scale system, the hardware-related tasks such as the installation task and the wire connection task as well as the software-related tasks such as initial setting and function setting are often assigned to specialist workers. In that case, for example, the workers responsible for performing the initial setting starts the task of initial setting after receiving a report of completion of the installation task from the workers who performed the hardware-related tasks. In this way, in the case of building a large-scale system, the workers performing the hardware-related tasks and the workers performing the software-related tasks build the system in liaison with each other. Prior art examples are disclosed in Japanese Laid-open Patent Publication No. 2014-95536, International Publication Pamphlet No. 96/29640, and Japanese Laid-open Patent Publication No. 2001-223721.

Meanwhile, depending on the system configuration, sometimes a redundant configuration is implemented in which a plurality of communication devices having the spanning tree protocol (STP) function is wire-connected in a loop configuration or in a mesh-like configuration. Alternatively, there are times when a link aggregation technology is implemented in which two communication devices are connected using a plurality of network cables, and the physical links using the network cables are bundled to be used as a single logical link.

There are some communication devices that start operations upon receiving supply of power. For that reason, in the state in which the STP function and the link aggregation function are not yet set, if a plurality of communication devices that receives supply of power is wire-connected in a loop configuration or in a mesh-like configuration, each individual communication device unlimitedly repeats the transfer of communication data. That causes the entire network to go down. In order to avoid such a situation, the communication devices are wire-connected to each other only after the STP function and the link aggregation function are set in each individual communication device.

However, if the hardware-related tasks, such as installation and wire connection, and the software-related tasks, such as initial setting and function setting, are performed in an alternate manner; then it results in frequent handover between the workers responsible for the hardware-related tasks and the workers responsible for the software-related tasks. Moreover, in the case of building a large-scale system, there are times when the workers responsible for the hardware-related tasks perform the tasks at distant locations from the workers responsible for the software-related tasks. In such a case, mistakes in handover become more likely to occur. If mistakes in handover occur among the workers, there are times when the built system does not function correctly.

### SUMMARY

According to an aspect of an embodiment, a communication device setting apparatus that performs setting in a plurality of communication devices, the communication device setting apparatus includes a selecting unit, a power supply control unit, and a setting unit. The selecting unit sequentially selects setting contents to be set in the communication devices whose wire connection has been completed. The power supply control unit supplies power to the communication devices in which the setting contents selected by the selecting unit are to be set among the plurality of communication devices. The setting unit performs setting according to the setting contents, which are selected by the selecting unit, to the communication devices to which power is supplied by the power supply control unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a communication device setting system;

FIG. 2 is a diagram illustrating an example of a device list;

FIG. 3 is a diagram illustrating an example of a condition list;

FIG. 4 is a diagram illustrating an example of a setting script;

FIG. 5 is a diagram illustrating an example of a sequence list;

FIG. 6 is a flowchart for explaining an example of the operations performed by a communication device setting apparatus;

FIG. 7 is a flowchart for explaining an example of a power supply control operation;

FIG. 8 is a flowchart for explaining an example of a setting operation; and

FIG. 9 is a diagram illustrating an example of a computer that implements the functions of the communication device setting apparatus.

### DESCRIPTION OF EMBODIMENT

Preferred embodiments of the present invention will be explained with reference to accompanying drawings. However, the technology disclosed herein is not limited to the embodiment described below.

Communication Device Setting System 10

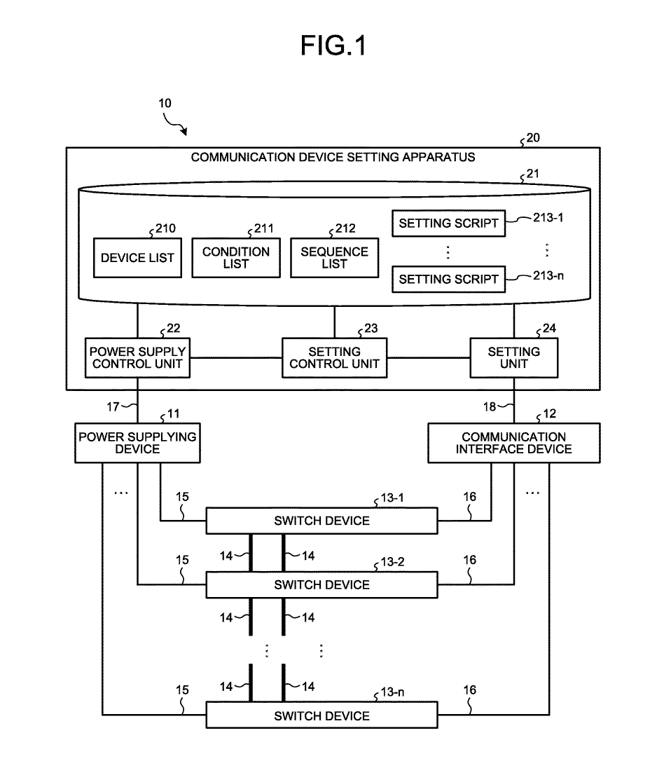

FIG. 1 is a diagram illustrating an example of a communication device setting system 10. The communication device setting system 10 includes a communication device setting apparatus 20, a power supplying device 11, a communication interface device 12, and a plurality of switch devices 13-1 to 13-n. In the following explanation, when the switch devices 13-1 to 13-n need not be distinguished from each other, they are collectively referred to as the switch devices 13.

The switch devices 13 are communication devices such as layer 3 switches. Each switch device 13 is connected to one or more other switch devices 13 via communication cables 14. Thus, each switch device 13 sends communication data to and receives communication data from other switch devices 13 via the communication cables 14. Moreover, each switch device 13 is connected to the power supplying device 11 via a power supply cable 15. When power is supplied from the power supplying device 11, each switch device 13 performs operations using the supplied power. In the embodiment, as a result of receiving the supply of power, the switch devices 13 reset and start the operations according to the setting stored in a nonvolatile memory thereof.

Meanwhile, each switch device 13 includes a maintenance port, which is connected to the communication interface device 12 via a communication cable 16. Thus, each switch device 13 performs initial setting and function setting according to the information received from the communication device setting apparatus 20 via the communication interface device 12.

In the embodiment, the initial setting of each switch device 13 includes, for example, the setting of a blocking port, the setting related to the STP, and the setting related to a virtual local area network (VLAN). In the case in which a plurality of switch devices 13 operates in liaison with each other and constitutes a cluster that behaves like a single virtual network switch, the initial setting with respect to each switch device 13 includes the setting about position information indicating the position in the cluster.

In the embodiment, the function setting with respect to a plurality of switch devices 13 includes, for example, the setting of cluster units in the case in which a plurality of switch devices 13 operates in liaison with each other and constitutes a cluster that behaves like a single virtual network switch. The setting of cluster units includes setting the structure or the configuration of the cluster, and assigning addresses to the cluster units. The function setting with respect to a group of a plurality of switch devices 13 is performed via one of the switch devices 13 included in the target group for setting. The switch device 13 in which the function setting has been done autonomously performs the function setting with respect to the other switch devices 13 in the group. For that reason, the function settings with respect to a group of a plurality of switch devices 13 is based on the premise that the switch devices 13 in the target group for setting are wire-connected to each other.

The power supplying device 11 includes a communication port and a plurality of power connectors. The communication port of the power supplying device 11 is connected to the communication device setting apparatus 20 via a communication cable 17. Each power connector is assigned with a connector number for identification purposes. Moreover, to each power connector is connected one of the switch devices 13 via the corresponding power supply cable 15.

When a control signal that specifies the connector number of a power connector to which the supply of power is to be started is received from the communication device setting apparatus 20 via the communication cable 17, the power supplying device 11 starts the supply of power to the power connector corresponding to the specified connector number. As a result, power gets supplied to the switch device 13 that is connected to the concerned power connector via the power supply cable 15, and the switch device 13 starts the operations.

When a control signal that specifies the connector number of a power connector whose power supply is to be stopped is received from the communication device setting apparatus 20 via the communication cable 17, the power supplying device 11 stops the supply of power to the power connector corresponding to the specified connector number. As a result, power that was being supplied to the switch device 13, which is connected to the concerned power connector via the power supply cable 15, gets cut off; and the switch device 13 stops the operations.

The communication interface device 12 includes a plurality of communication ports. Each communication port is assigned with a port number for identification purposes. One of the communication ports is connected to the communication device setting apparatus 20 via a communication cable 18. To each of the remaining communication ports is connected one of the switch devices 13 via the corresponding communication cable 16.

When communication data is received along with a port number from the communication device setting apparatus 20, the communication interface device 12 sends the received communication data to the switch device 13 that is connected to the communication port having the port number received along with the communication data. Moreover, when communication data is received from the switch device 13, the communication interface device 12 sends the received communication data along with the port number of the communication port that received the communication data to the communication device setting apparatus 20 via the communication cable 18.

In the embodiment, in the initial state, the power supplying device 11 does not supply power to any power connector. Hence, even if the switch devices 13 are connected to the power supplying device 11 via the respective power supply cables 15, none of the switch devices 13 are activated in the initial state. For that reason, even if each switch device 13 is connected to other switch devices 13 using the communication cables 14 thereby resulting in the wire connection of a plurality of switch devices 13 in a loop configuration or in a mesh-like configuration, there is no unlimited transfer of communication data in the initial state.

Moreover, in the embodiment, when the installation task and the wire connection task of a plurality of switch devices 13 are performed, and after the wire connection task is completed; the setting task is performed with respect to each switch device 13. The wire connection task of a plurality of switch devices 13 includes the task of connecting each switch device 13 to a power connector of the power supplying device 11 via the corresponding power supply cable 15, and the task of connecting each switch device 13 to other switch devices 13 via the communication cables 14. Moreover, the wire connection task of a plurality of switch devices 13 also includes the task of connecting each switch device 13 to a communication port of the communication interface device 12 via the corresponding communication cable 16.

Communication Device Setting Apparatus 20

For example, as illustrated in FIG. 1, the communication device setting apparatus 20 includes a memory unit 21, a power supply control unit 22, a setting control unit 23, and a setting unit 24. The memory unit 21 is used to store a device list 210, a condition list 211, a sequence list 212, and a plurality of setting scripts 213-1 to 213-n. In the following explanation, when the setting scripts 213-1 to 213-n need not be distinguished from each other, they are collectively referred to as the setting scripts 213. Meanwhile, the information that is stored in the memory unit 21 is created in advance by the user of the communication device setting apparatus 20 and is then stored in the memory unit 21.

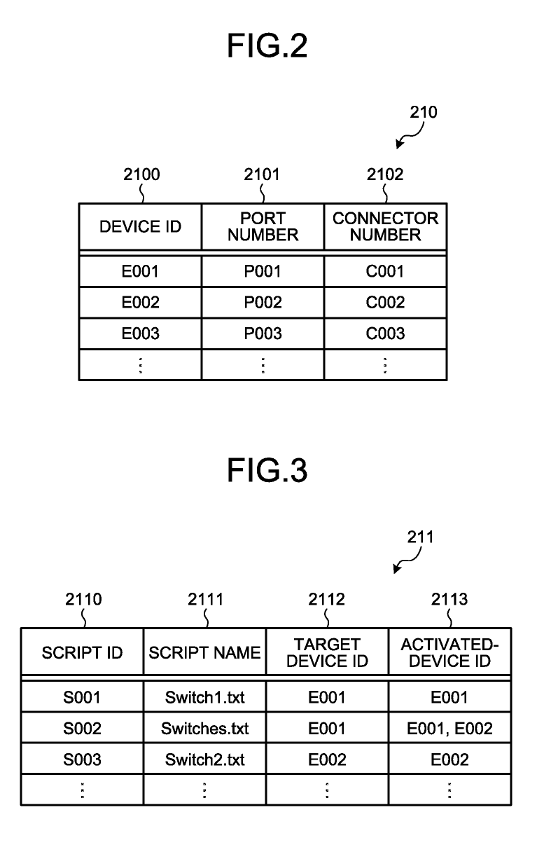

FIG. 2 is a diagram illustrating an example of the device list 210. For example, as illustrated in FIG. 2, in the device list 210, device IDs 2100 that enable identification of the switch devices 13 are stored in a corresponding manner to port numbers 2101 and connector numbers 2102. The port numbers 2101 represent information that enables identification of such communication ports of the communication interface device 12 which are connected to the switch devices 13 identified by the device IDs 2100. The connector numbers 2102 represent information that enables identification of such power connectors of the power supplying device 11 which are connected to the switch devices 13 identified by the devices IDs 2100.

By referring to the device list 210 illustrated in FIG. 2, it can be understood that, for example, to the switch device 13 having “E001” as the device ID 2100 is connected the communication port having “P001” as the port number 2101 in the communication interface device 12. Moreover, for example, to the switch device 13 having “E001” as the device ID 2100 is connected the power connector having “C001” as the connector number 2102 in the power supplying device 11.

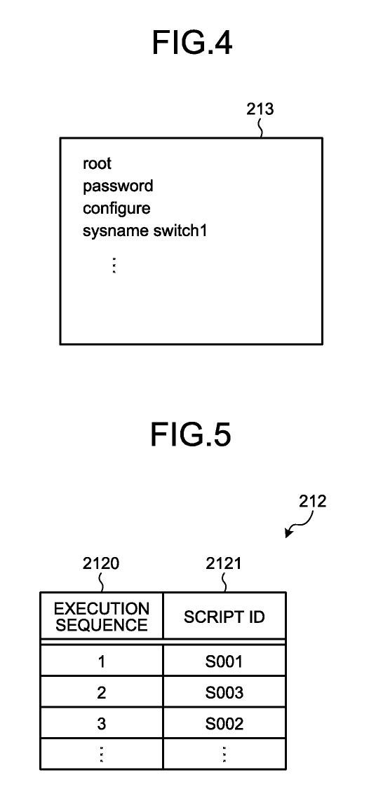

FIG. 3 is a diagram illustrating an example of the condition list 211. In the condition list 211, script IDs 2110 that enable identification of the setting scripts 213 are stored in a corresponding manner to script names 2111, target device IDs 2112, and activated-device IDs 2113. For example, as illustrated in FIG. 4, the setting scripts 213 include a series of commands and data used in the setting. The series of commands and data included in the setting scripts 213 represents an example of setting contents.

The script names 2111 represent names of the setting scripts 213 identified by the script IDs 2110. The target device IDs 2112 represent device IDs of the switch devices 13 that perform setting-related communication with the communication device setting apparatus 20 based on the setting scripts 213 identified by the script IDs 2110.

For example, regarding the script IDs of the setting scripts 213 that are related to the initial setting of the individual switch devices 13, the device ID of a single switch device 13 in which initial setting is to be performed is stored as the target device ID 2112 in the condition list 211. Moreover, regarding the script IDs of the setting scripts 213 that are related to the function setting of a cluster-like group of a plurality of switch devices 13, the device ID of one of the switch devices 13 in the group is stored as the target device ID 2112 in the condition list 211. In the function setting with respect to the group of a plurality of switch devices 13, the function setting is performed with respect to one of the switch devices 13 included in the group, and that switch device 13 then autonomously performs the setting in the other switch devices 13 included in the group. As a result, the function setting of the entire group is achieved.

The activated-device IDs 2113 represent device IDs of one or more switch devices 13 in which setting is done using the setting scripts 213 identified by the script IDs 2110. Regarding the script IDs of the setting scripts 213 that are related to the initial setting of the individual switch devices 13, the device ID of a single switch device 13 in which initial setting is to be performed is stored as the activated-device ID 2113 in the condition list 211. Moreover, regarding the script IDs of the setting scripts 213 that are related to the function setting of a cluster-like group of a plurality of switch devices 13, the device IDs of all switch devices 13 in the group are stored as the activated-device IDs 2113 in the condition list 211.

By referring to the condition list 211 illustrated in FIG. 3, it can be understood that, for example, when the setting script 213 having “S002” as the script ID 2110 is executed, the setting script 213 having “Switches.txt” as the script name 2111 is used. Moreover, it can be understood that, when the setting script 213 having “S002” as the script ID 2110 is executed, commands and data according to that setting script 213 are sent to the switch device 13 having “E001” as the target device ID 2112. Furthermore, it can be understood that, when the setting script 213 having “S002” as the script ID 2110 is executed, the switch devices 13 having “E001” and “E002” included in the activated-device IDs 2113 are to be activated.

FIG. 5 is a diagram illustrating an example of the sequence list 212. In the sequence list 212, an execution sequence 2120 indicating the sequence of execution is stored in a corresponding manner to script IDs 2121. By referring to the sequence list 212 illustrated in FIG. 5, it can be understood that the sequence of execution of the setting scripts 213 is in the order of “S001”, “S003”, and “S002” representing the script IDs 2121. Meanwhile, in the sequence list 212 according to the embodiment, the execution sequence of the setting scripts is set in such a way that the setting script related to the initial setting of each switch device 13 is executed before the setting script related to the function setting of a plurality of switch devices 13.

Returning to the explanation with reference to FIG. 1, when a setting start instruction is received from the user, the setting control unit 23 sequentially selects the script IDs according to the sequence of execution stored in the sequence list 212 in the memory unit 21. Then, the setting control unit 23 sends the selected script ID to the power supply control unit 22. When a notification about the completion of power control is received from the power supply control unit 22, the setting control unit 23 sends the selected script ID to the setting unit 24. When a notification about the completion of setting is received from the setting unit 24, the setting control unit 23 refers to the sequence list 212 and selects the next script ID according to the sequence of execution.

When a script ID is received from the setting control unit 23, the power supply control unit 22 refers to the condition list 211 in the memory unit 21, and identifies the activated-device IDs corresponding to the script ID received from the setting control unit 23. Then, the power supply control unit 22 refers to the device list 210 and, for each identified activated-device ID, identifies the connector number of such a power connector in the power supplying device 11 which is connected to the switch device 13 having the concerned activated-device ID.

Then, the power supply control unit 22 sends a control signal to the power supplying device 11 via the communication cable 17 so as to ensure that power is supplied only to the power connectors having the identified connector numbers. As a result, the power supplying device 11 supplies power only to the power connectors having the connector numbers identified by the power supply control unit 22. Then, the power supply control unit 22 notifies the setting control unit 23 about the completion of power control.

When a script ID is received from the setting control unit 23, the setting unit 24 refers to the condition list 211 in the memory unit 21, and identifies the script name corresponding to the script ID received from the setting control unit 23. Then, the setting unit 24 obtains the setting script 213 having the identified script name from the memory unit 21.

Subsequently, the setting unit 24 refers to the condition list 211 in the memory unit 21, and identifies the target device ID corresponding to the script ID received from the setting control unit 23. Then, the setting unit 24 refers to the device list 210 in the memory unit 21, and identifies the port number corresponding to the same device ID as the identified target device ID.

Subsequently, the setting unit 24 sequentially generates commands and data according to the setting script 213 obtained by the memory unit 21; and sends the generated commands and data along with the port number, which is identified by referring to the device list 210, to the communication interface device 12. Then, the communication interface device 12 sends the command and data, which are sequentially received from the setting unit 24, to the switch device 13 that is connected to the communication port having the port number received from the communication device setting apparatus 20. As a result, the setting according to the setting script 213 is performed with respect to the switch device 13 to which power is supplied by the power supply control unit 22. After the setting according to the setting script 213 is over, the setting unit 24 notifies the setting control unit 23 about the completion of setting.

Herein, in the sequence list 212 according to the embodiment, the sequence of execution of the setting scripts is set in such a way that the setting scripts related to the initial setting of individual switch devices 13 are executed before the setting script related to the function setting of a plurality of switch devices 13. Moreover, in the condition list 211, the device IDs of all switch devices 13 in which setting is performed using a script ID are registered as the activated-device IDs corresponding to the script ID of the concerned setting script.

Subsequently, when a script ID is received from the setting control unit 23, the power supply control unit 22 identifies the activated-device IDs corresponding to the received script ID in the condition list 211. Then, the power supply control unit 22 ensures that power is supplied only to the switch devices 13 having the device IDs specified as the identified activated-device IDs. Thus, other than the switch devices 13 in which the setting is performed using the setting script, the remaining switch devices 13 do not receive the supply of power and are not activated. For that reason, at the time of performing the initial setting of the individual switch devices 13, power is supplied only to the target switch devices 13 for setting and not to the other switch devices 13.

As a result, even in the case in which the wire connection task is already performed for a plurality of switch devices 13 thereby resulting in a loop configuration, until the initial setting in the individual switch devices 13 is completed, not all switch devices 13 constituting the loop configuration are activated. For that reason, at the stage of performing the initial setting in the individual switch devices 13, there is no unlimited transfer of communication data and the setting of blocking ports and aggregation ports can be performed.

In the individual switch devices 13, as long as the setting of blocking ports and aggregation ports is over, even if a plurality of switch devices 13 that is wire-connected in a loop configuration is activated, there is no unlimited transfer of communication data. For that reason, after the completion of the initial setting of the individual switch devices 13, the setting such as cluster setting can be performed on an ongoing basis with respect to the switch devices 13.

In this way, power is sequentially supplied to only a minimum of switch devices 13 in which setting is to be performed, and the initial setting of the individual switch devices 13 is performed first. As a result, even if a plurality of switch devices 13 is wire-connected in a loop configuration, the initial setting of the individual switch devices 13 can be completed without causing unlimited transfer of communication data. For that reason, all hardware-related tasks such as the wire connection task of wire-connecting a plurality switch devices 13 can be completed first, and then all software-related tasks including the initial setting of the individual switch devices 13 and the function setting with respect to a plurality of switch devices can be performed.

That enables achieving reduction in the number of times of handover between the workers who perform the hardware-related tasks and the workers who perform the software-related tasks. Consequently, it becomes possible to hold down the coordination mistakes during the handover. Moreover, since it becomes possible to omit the task of confirmation or reporting that is intended to prevent the coordination mistakes during the handover, the overall operation time can be shortened.

Operations Performed by Communication Device Setting Apparatus 20

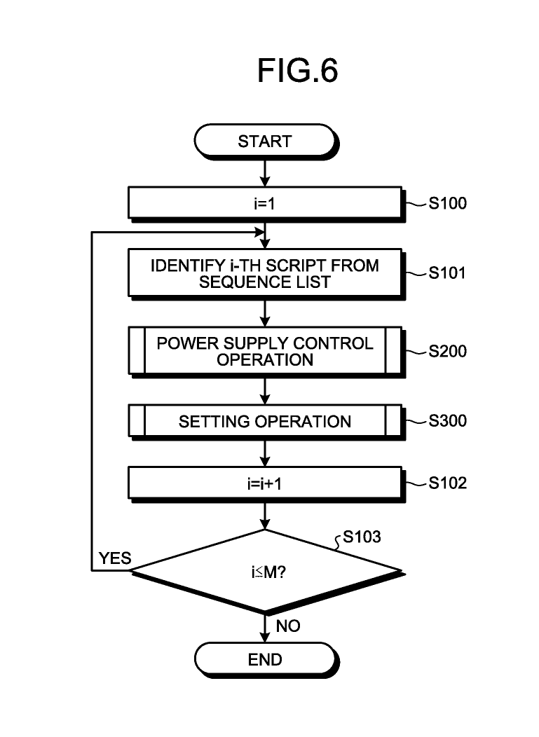

FIG. 6 is a flowchart for explaining an example of the operations performed by the communication device setting apparatus 20. Prior to the operations illustrated in the flowchart, the task of installing and wire-connecting the target switch devices 13 for setting is performed. Once the task of installation and wire connection is finished, when a setting start instruction is received from the user of the communication device setting apparatus 20, the communication device setting apparatus 20 starts the operations illustrated in the flowchart.

Firstly, the setting control unit 23 sets a variable i to 1 (S100). Then, the setting control unit 23 refers to the sequence list 212 in the memory unit 21, and identifies the i-th script ID (S101). Subsequently, the setting control unit 23 sends the identified script ID to the power supply control unit 22.

Then, the power supply control unit 22 performs a power supply control operation (described later) (S200). Subsequently, the power supply control unit 22 notifies the setting control unit 23 about the completion of power control. Then, the setting control unit 23 sends the script ID, which is identified at Step S101, to the setting unit 24. The setting unit 24 performs a setting operation (described later) (S300). Then, the setting unit 24 notifies the setting control unit 23 about the completion of setting.

Subsequently, the setting control unit 23 increments the variable i by one (S102). Then, the setting control unit 23 determines whether or not the variable i is equal to or smaller than a constant number M (S103). Herein, the constant number M indicates the number of setting scripts 213 stored in the memory unit 21. If the variable i is equal to or smaller than the constant number M (Yes at S103), the setting control unit 23 again performs the operation at Step S101. However, if the variable i is greater than the constant number M (No at S103), that is, if all setting scripts have been executed; then the communication device setting apparatus 20 ends the operations illustrated in the flowchart.

When the execution of all setting scripts is over, the power supply control unit 22 controls the power supplying device 11 so that the supply of power is started to all switch devices 13. With that, the operations of the system configured with a plurality of switch devices 13 can be started.

Power Supply Control Operation

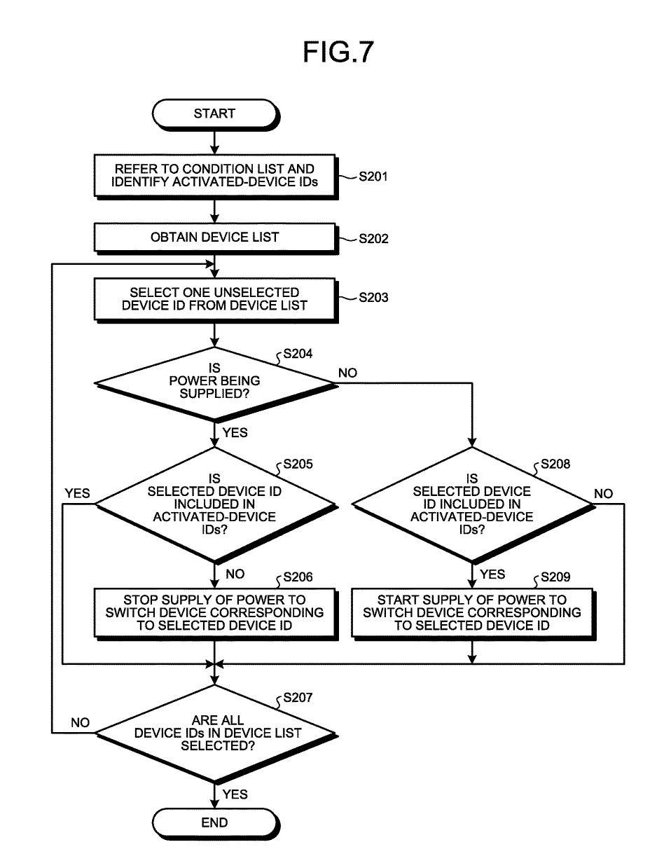

FIG. 7 is a flowchart for explaining an example of the power supply control operation.

Firstly, the power supply control unit 22 refers to the condition list 211 and identifies the activated-device IDs corresponding to the script ID received from the setting control unit 23 (S201). Then, the power supply control unit 22 obtains the device list 210 from the memory unit 21 (S202).

Subsequently, the power supply control unit 22 selects one unselected device ID from the device list 210 (S203). Then, the power supply control unit 22 refers to the device list 210 and identifies the connector number corresponding to the selected device ID, and determines whether or not power is being supplied to the power connector having the identified connector number (S204). Herein, the power supply control unit 22 is managing the power supply status of each power connector of the power supplying device 11.

If power is being supplied to the power connector having the identified connector number (Yes at S204), then the power supply control unit 22 determines whether or not the device ID selected at Step S203 is included in the activated-device IDs identified at Step S201 (S205). If the device ID selected at Step S203 is included in the activated-device IDs identified at Step S201 (Yes at S205), then the power supply control unit 22 performs the operation at Step S207.

On the other hand, if the device ID selected at Step S203 is not included in the activated-device IDs identified at Step S201 (No at S205), then the power supply control unit 22 refers to the device list 210 and identifies the connector number corresponding to the device ID selected at Step S203. Then, the power supply control unit 22 sends, to the power supplying device 11, a control signal as an instruction for stopping the supply of power to the power connector having the identified connector number; and thus stops the supply of power to the switch device 13 having the device ID selected at Step S203 (S206). Subsequently, the power supply control unit 22 performs the operation at Step S207.

Meanwhile, if power is not being supplied to the power connector having the identified connector number (No at S204), then the power supply control unit 22 determines whether or not the device ID selected at Step S203 is included in the activated-device IDs identified at Step S201 (S208). If the device ID selected at Step S203 is not included in the activated-device IDs identified at Step S201 (No at S208), then the power supply control unit 22 performs the operation at Step S207.

On the other hand, if the device ID selected at Step S203 is included in the activated-device IDs identified at Step S201 (Yes at S208), then the power supply control unit 22 refers to the device list 210 and identifies the connector number corresponding to the device ID selected at Step S203. Then, the power supply control unit 22 sends, to the power supplying device 11, a control signal as an instruction for starting the supply of power to the power connector having the identified connector number; and thus starts the supply of power to the switch device 13 having the device ID selected at Step S203 (S209).

Subsequently, the power supply control unit 22 determines whether or not all device IDs in the device list 210 have been selected (S207). If there is any unselected device ID in the device list 210 (No at S207), then the power supply control unit 22 again performs the operation at Step S203. When all device IDs in the device list 210 have been selected (Yes at S207), the power supply control unit 22 ends the power supply control operation illustrated in the flowchart.

Setting Operation

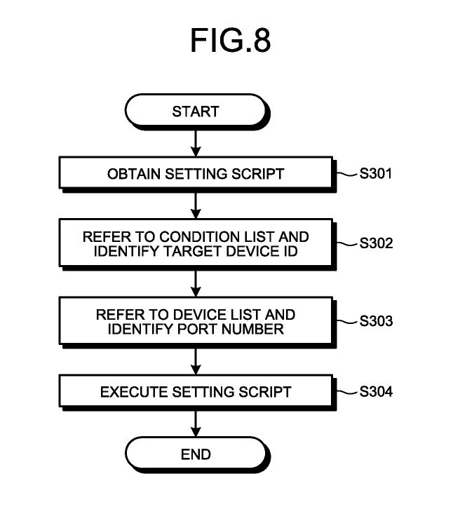

FIG. 8 is a flowchart for explaining an example of the setting operation.

Firstly, the setting unit 24 refers to the condition list 211 in the memory unit 21 and identifies the script name corresponding to the script ID received from the setting control unit 23. Then, the setting unit 24 obtains the setting script having the identified script name from the memory unit 21 (S301).

Subsequently, the setting unit 24 refers to the condition list 211 in the memory unit 21 and identifies the target device ID corresponding to the script ID received from the setting control unit 23 (S302). Then, the setting unit 24 refers to the device list 210 in the memory unit 21 and identifies the port number corresponding to the same device ID as the identified target device ID (S303).

Subsequently, the setting unit 24 executes the setting script obtained at Step S301 (S304). At Step S304, the setting unit 24 sequentially generates commands and data according to the setting script and sends the generated commands and data along with the port number identified at Step S303 to the communication interface device 12. The communication interface device 12 then sends the commands and data, which are received from the setting unit 24, to the switch device 13 connected to the communication port having the port number received from the setting unit 24. When the execution of the setting script is over, the setting unit 24 ends the setting operation illustrated in the flowchart.

### Effect of Embodiment

In the communication device setting system 10 according to the embodiment, the setting control unit 23 sequentially selects the script IDs of the setting scripts in which the setting contents are written with respect to the switch devices 13 whose wire connection has been completed. Then, the power supply control unit 22 performs control in such a way that power is supplied only to such switch devices 13 which are targeted by the setting scripts having the script IDs selected by the setting control unit 23. Then, with respect to the switch devices 13 that are supplied with power by the power supply control unit 22, the setting unit 24 performs setting according to the setting scripts having the script IDs selected by the setting control unit 23.

As a result, before the setting is performed in each switch device 13 according to a setting script, the task of installation and wire connection of all switch devices 13 can be completed. That enables achieving reduction in the number of times of handover between the hardware-related tasks and the software-related tasks. Consequently, it becomes possible to hold down the coordination mistakes between the hardware-related tasks and the software-related tasks.

The memory unit 21 is used to store the condition list 211 in which the script IDs, which enable identification of the setting scripts having the setting contents written therein, are stored in a corresponding manner to the target-device IDs, which represent identification information of the switch devices 13 in which setting is to be performed based on the setting scripts. As a result, it becomes possible for the setting unit 24 to easily identify the device IDs of the switch devices 13 that are targeted by the setting scripts having the script IDs selected by the setting control unit 23.

Moreover, the memory unit 21 is used to store the sequence list 212 indicating the sequence of execution of the setting scripts. Thus, the setting control unit 23 can sequentially select the script IDs of the setting scripts according to the sequence of execution registered in advance in the sequence list 212. Besides, by varying the sequence of execution in the sequence list 212, the setting scripts can be executed in an arbitrary sequence.

In the sequence list 212, the sequence of execution of the setting scripts is set in such a way that the setting scripts related to the initial setting of individual switch devices 13 are executed before the setting script related to the setting of the group of a plurality of switch devices 13. That enables achieving prevention of unlimited transfer of communication data by a plurality of switch devices 13.

Furthermore, the memory unit 21 is used to store the device list 210 in which the switch devices 13, the port numbers of the communication ports connected to the switch devices 13, and the connector numbers of the power connectors connected to the switch devices 13 are stored in a corresponding manner. With that, it becomes possible for the power supply control unit 22 to easily identify the connector numbers of the power connectors that are connected to the switch devices 13 targeted by the setting scripts having the script IDs selected by the setting control unit 23. Moreover, it becomes possible for the setting unit 24 to easily identify the port numbers of the communication ports that are connected to the switch devices 13 targeted by the setting scripts having the script IDs selected by the setting control unit 23.

Hardware

Meanwhile, in the embodiment described above, the constituent elements of the device illustrated in the drawings are merely conceptual, and need not be physically configured as illustrated. The constituent elements, as a whole or in part, can be separated or integrated either functionally or physically based on various types of loads or use conditions.

Moreover, some or all of the various processing functions implemented in the devices can be implemented in a central processing unit (CPU) (or a microcomputer such as a micro processing unit (MPU) or a micro controller unit (MCU)). Moreover, it is needless to say that some or all of the various processing functions either can be implemented using computer programs analyzed and executed in a CPU (or a microcomputer such as an MPU or an MCU) or can be implemented in hardware such as a wired logic.

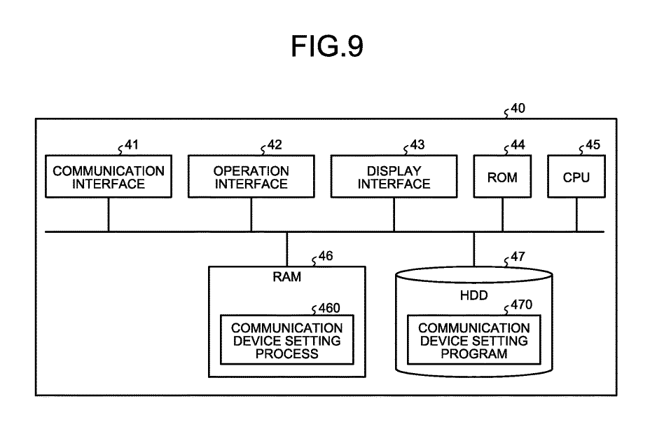

Meanwhile, the various operations explained in the embodiment can be performed by executing prewritten computer programs in a computer. Given below is the explanation of an exemplary computer that executes a computer program for implementing identical functions to the functions of the communication device setting apparatus 20 explained in the embodiment. FIG. 9 is a diagram illustrating an example of a computer 40 that implements the functions of the communication device setting apparatus.

For example, as illustrated in FIG. 9, the computer 40 includes a communication interface 41, an operation interface 42, a display interface 43, a read only memory (ROM) 44, a CPU 45, a random access memory (RAM) 46, and a hard disk drive (HDD) 47.

For example, as illustrated in FIG. 9, in the HDD 47, a communication device setting program 470 is stored in advance. The CPU 45 reads the communication device setting program 470 from the HDD 47, and loads it in the RAM 46. The communication device setting program 470 can be appropriately integrated or separated in an identical manner to the constituent elements illustrated in FIG. 1. Meanwhile, the data stored in the HDD 47 need not be entirely and constantly stored in the HDD 47. Alternatively, only the data to be used in the operations can be stored in the HDD 47.

The CPU 45 makes the communication device setting program 470 function as a communication device setting process 460, which loads a variety of data read from the HDD 47 in an area assigned thereto in the RAM 46 and performs various operations based on the variety of loaded data. In the embodiment, when the CPU 45 reads the communication device setting program 470 and executes it, it results in the implementation of functions identical to the power supply control unit 22, the setting control unit 23, and the setting unit 24.

Meanwhile, the communication device setting process 460 according to the embodiment executes the operations performed by the power supply control unit 22, the setting control unit 23, and the setting unit 24 illustrated in FIG. 1, that is, executes the operations illustrated in FIGS. 6 to 8. The processing units that are virtually implemented by the CPU 45 need not be entirely and constantly implemented by the CPU 45. Alternatively, only the processing units to be used in the operations can be virtually implemented.

Meanwhile, the communication device setting program 470 is not necessarily stored in the HDD 47 or the ROM 44 from the beginning. Alternatively, for example, the communication device setting program 470 is stored in a portable recording medium such as a flexible disk (FD), a CD-ROM, a DVD disk, a magneto-optical disk, and an IC card that can be inserted in the computer 40. Then, the computer 40 can obtain the communication device setting program 470 from the portable recording medium and execute it. Alternatively, the computer 40 can obtain the communication device setting program 470 from another computer or a server device, in which the communication device setting program 470 is stored, via a public line, the Internet, a local area network (LAN), or a wide area network (WAN); and can execute the communication device setting program 470.

The CPU 45 sequentially selects the target switch devices 13 for setting from among a plurality of switch devices 13 whose wire connection has been completed. Moreover, the CPU 45 performs control to supply power only the selected switch devices 13. Furthermore, the CPU 45 performs setting in the selected switch devices 13. As a result, in the case of performing setting in each switch device 13, power is supplied only to the switch device 13 in which setting is to be performed. Hence, even if a plurality of switch devices 13 is wire-connected in a loop configuration, there is no unlimited transfer of communication data. Hence, the setting of each switch device 13 can be performed without causing the network to go down. As a result, after the hardware-related tasks such as the wire connection task are completed, the software-related tasks such as the initial setting and the function setting can be performed at one go. That enables achieving reduction in the number of times of handover between the workers who perform the hardware-related tasks and the workers who perform the software-related tasks. Consequently, it becomes possible to hold down the setting mistakes attributed to the mistakes in handover.

Miscellaneous

In the embodiment described above, the power supply control unit 22 selects the device IDs one at a time from the device list 210, and determines whether or not the selected device ID is included in the activated-device IDs that are identified based on the script ID received from the setting control unit 23. If the selected device ID is included in the activated-device IDs, then the power supply control unit 22 starts the supply of power to the switch device 13 having the selected device ID. On the other hand, if the selected device ID is not included in the activated-device IDs, then the power supply control unit 22 stops the supply of power to the switch device 13 having the selected device ID.

However, the technology disclosed herein is not limited to that case. Alternatively, for example, when a script ID is received from the setting control unit 23, the power supply control unit 22 firstly stops the supply of power to all switch devices 13. Then, the power supply control unit 22 starts the supply of power to the switch devices 13 having the activated-device IDs identified based on the script ID received from the setting control unit 23. As a result, it becomes possible to definitely prevent a situation in which a plurality of switch devices 13 that is connected in a loop configuration gets activated.

Moreover, in the embodiment described above, the power supplying device 11, the communication interface device 12, and the communication device setting apparatus 20 are explained as separate devices. However, the technology disclosed herein is not limited to that case. Alternatively, for example, an apparatus having the functions of the power supplying device 11, the communication interface device 12, and the communication device setting apparatus 20 can be configured as a communication device setting apparatus.

According to an aspect of the embodiment, it becomes possible to hold down the coordination mistakes between the workers who perform the hardware-related tasks and the workers who perform the software-related tasks.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication device setting apparatus that performs setting in a plurality of communication devices, the communication device setting apparatus comprising:
a selecting unit that sequentially selects setting contents to be set in the communication devices whose wire connection has been completed;
a power supply control unit that supplies power to the communication devices in which the setting contents selected by the selecting unit are to be set among the plurality of communication devices; and
a setting unit that performs setting according to the setting contents, which are selected by the selecting unit, to the communication devices to which power is supplied by the power supply control unit.

2. The communication device setting apparatus according to claim 1, further comprising a memory unit that is used to store a condition list in which first identification information, which enables identification of the setting contents, is held in a corresponding manner to second identification information, which represents identification information of the communication devices in which the setting contents are to be set, wherein
the selecting unit refers to the condition list and sequentially selects the first identification information as the setting contents, and
the setting unit refers to the condition list and, according to the setting contents indicated by the first identification information that is selected by the selecting unit, performs setting in communication devices identified by the second identification information that corresponds to the first identification information selected by the selecting unit.

3. The communication device setting apparatus according to claim 2, wherein
the memory unit is used to further store a sequence list indicating sequence of execution of the setting contents, and
the selecting unit sequentially selects the first identification information, which enables identification of the setting contents, according to the sequence of execution specified in the sequence list.

4. The communication device setting apparatus according to claim 3, wherein, in the sequence list, the sequence of execution of the setting contents is set in such a way that setting contents related to initial setting of each of the communication devices are executed before setting contents related to setting with respect to a group of a plurality of the communication devices.

5. The communication device setting apparatus according to claim 2, wherein
the memory unit is used to further store a device list in which the communication devices, port numbers of communication ports to which the communication devices are connected, and connector numbers of power connectors to which the communication devices are connected are held in a corresponding manner,
the power supply control unit
refers to the device list,
identifies connection numbers of power connectors connected to the communication devices in which the setting contents selected by the selecting unit are to be set, and
supplies power to the communication devices, in which the setting contents selected by the selecting unit are to be set, via the power connectors having the identified connector numbers, and
the setting unit
refers to the device list,
identifies port numbers of communication ports connected to the communication devices in which the setting contents selected by the selecting unit are to be set, and
performs setting in the communication devices, in which the setting contents selected by the selecting unit are to be set, via the communication ports having the identified port numbers.
